(19) United States
(12) Patent Application Publication
(10) Pub. No.: US 2005/0095561 A1
(43) Pub. Date: May 5, 2005

(54) Device for applying dental treatment agent to teeth and/or gums

(76) Inventor: Reinhard Schatzner, Aigen (AT)

Correspondence Address: LERNER AND GREENBERG, PA, P O BOX 2480, HOLLYWOOD, FL, 33022-2480, US

(21) Appl. No.: 10/980,030

(22) Filed: Nov. 3, 2004

Related U.S. Application Data
(63) Continuation of application No. PCT/EP03/01105, filed on Feb. 5, 2003.

(30) Foreign Application Priority Data
May 3, 2002 (AT) A 689/2002

(51) Int. Cl. A61C 1/00; A61C 17/00

(52) U.S. Cl. 433/215; 433/80

(57) ABSTRACT

A device is configured for applying dental treatment agent to the teeth and/or the gums of a patient. The dental treatment agent is applied to the teeth and gums by way of a plastic carrier that is formed of a bitable, soft plastic matrix. The dental treatment agent is enclosed in hollow spaces formed in the soft plastic matrix.

### CROSS-REFERENCE TO RELATED APPLICATION

This is a continuing application, under 35 U.S.C. § 120, of copending international application No. PCT/EP03/01105, filed Feb. 5, 2003, which designated the United States; this application also claims the priority, under 35 U.S.C. § 119, of Austrian patent application A 689/2002, filed May 3, 2002; the prior applications are herewith incorporated by reference in their entirety.

### BACKGROUND OF THE INVENTION

### FIELD OF THE INVENTION

The invention relates to a device for applying dental treatment agent to teeth and/or gums. The dental treatment agent is applied to the teeth and gums by way of a plastic support carrier.

Many agents applied to the teeth and/or gums for cosmetic reasons or medical reasons or for oral hygiene must be able to act for a given length of time. It is thus necessary to ensure that they are not diluted by the saliva and swallowed.

To apply dental bleaching agent, it has become known to introduce the bleaching agent into a thermoformed or formable splint which the dentist has prepared individually for the person to be treated. This splint then has to be kept in the person's mouth for the duration of action of the agent. Disadvantages of this are the cost and outlay involved in producing the thermoformed splint, and the handling of the bleaching agent when introducing it into the splint.

Strip-shaped supports carrying a layer of bleaching agent are also known for application of dental bleaching agent. These strips, however, are difficult to adapt to the structure of a set of teeth, so that not all areas come into contact with the dental bleaching agent, resulting in irregular whitening. A further problem is that the layer of bleaching agent reacts prematurely upon contact with air.

U.S. Pat. No. 3,416,527 to Hoef describes a flat plastic carrier which, prior to patient application, is pressed into a mold in order to form a U-shaped trough. Treatment agent is then introduced into the trough and the carrier is placed into the patient's mouth. The patient's teeth project into the trough and are exposed to the bleaching agent for a given treatment time.

U.S. Pat. No. 6,274,122 to McLaughlin describes a substantially U-shaped plastic rail. A treatment layer inside the trough of the plastic rail is covered with a porous inner liner. The treatment agent penetrates through the liner when aqueous solution is introduced into the trough.

U.S. Pat. No. 3,844,286 to Cowen describes an I-beam carrier formed with opposing troughs for the lower and upper dental rows. The treatment agent is applied to each of the troughs so that the upper and lower teeth can be treated simultaneously.

The prior art devices have in common that the treatment agent is not hermetically protected until it comes into contact with the teeth to be treated. That is, the treatment agent is exposed to the air, so that oxidation prior to application cannot be avoided, and in some cases it is possible that the agent comes into contact with the fingers during handling and insertion into the patient's mouth. Finally, complete and even exposure of the teeth to the treatment agent is not ensured in some cases because the shape of the applicator is not entirely adapted to the shape of the teeth.

### SUMMARY OF THE INVENTION

It is accordingly an object of the invention to provide an applicator device for applying dental treatment agent to the teeth and/or gums which overcomes the above-mentioned disadvantages of the heretofore-known devices and methods of this general type and which provides for a device that ensures simple, quick, inexpensive, safe, and even application.

With the foregoing and other objects in view there is provided, in accordance with the invention, a device for applying dental treatment agent, comprising:
a plastic carrier having a soft, bitable plastic matrix with closed hollow spaces; and
dental treatment agent enclosed in the closed hollow spaces of the plastic matrix.

In other words, the objects of the invention are achieved with a carrier or support that is a biteable, soft plastic matrix and wherein the dental treatment agent is enclosed in hermetically closed hollow spaces in the matrix. When the patient, i.e., the person being treated, bites into the plastic matrix, the walls surrounding the hollow spaces burst and the dental treatment agent escapes and is exposed to the teeth. The deformed matrix is held for the desired time between the teeth, and the matrix is then removed and disposed of and the mouth rinsed. The soft matrix automatically affords the correct and exact fit, ensuring complete contact between dental treatment agent and teeth, even when small quantities of dental treatment agent are applied.

Complicated production and adaptation of a splint is done away with. Moreover, there is no need to handle an extra bottle containing the dental treatment agent. With the device according to the invention, it is now possible for anyone to apply dental bleaching agent, for example, without the aid of a dentist and with self-application.

The terms bitable and soft are defined herein in the context of the dental application. The term bitable means that the carrier has a degree of hardness that allows deformation upon being subjected to a typical human biting force. The term soft, similarly, is understood to mean that the biting force relatively easily deforms the matrix and ruptures the enclosing walls of the hollow spaces.

A diameter of the hollow spaces of 2 mm or less is sufficient to cover the tooth surface.

According to a particular embodiment, the hollow spaces are distributed with different density in the matrix, for example corresponding to the amount of dental treatment agent required in the oral cavity. Alternatively, or in addition, the dental treatment agent can be present in different concentration in the hollow spaces so as to provide a desired distribution of the action in the oral cavity, and/or the hollow spaces have different sizes.

It is also possible for the hollow spaces to contain different dental treatment agents in different areas of the matrix, if different treatments are desired in different areas of the mouth.

Preferably, the plastic matrix is permanently deformable, so that, after it has been initially bitten into to adapt it to the set of teeth and to release the dental treatment agent enclosed in the hollow spaces, no counter-pressure is present during the period of action of the dental treatment agent.

The dental treatment agent can in particular be a dental bleaching agent, for example carbamide peroxide or hydrogen peroxide, a medicament for teeth or gums and/or an oral hygiene agent for teeth and/or gums, for example fluoride. Apart from bleaching agents, other examples of agents for treating the teeth and/or gums include disinfectants, local anesthetics, or, for instance, petroleum jelly.

The matrix can be produced in different thicknesses according to the individual heights of the teeth, can be deformable, or can be cut to the desired shape with scissors.

Other features which are considered as characteristic for the invention are set forth in the appended claims.

Although the invention is described herein as embodied in a device for applying dental treatment agent to teeth and/or gums, it is nevertheless not intended to be limited to the exemplary details, since various modifications and structural changes may be made therein without departing from the spirit of the invention and within the scope and range of equivalents of the claims.

1. A device for applying dental treatment agent, comprising:
a plastic carrier having a soft, bitable plastic matrix with closed hollow spaces; and
dental treatment agent enclosed in said closed hollow spaces of said plastic matrix.

2. The device according to claim 1, wherein said hollow spaces have a maximum diameter of 2 mm.

3. The device according to claim 1, wherein said hollow spaces are distributed within said matrix with variable density.

4. The device according to claim 1, wherein said dental treatment agent is present in different concentration in said hollow spaces.

5. The device according to claim 1, wherein said hollow spaces have different sizes.

6. The device according to claim 1, wherein said hollow spaces contain different dental treatment agents in different areas of said matrix.

7. The device according to claim 1, wherein the plastic matrix is permanently deformable.

8. The device according to claim 1, wherein said dental treatment agent is a dental bleaching agent.

9. The device according to claim 8, wherein said dental bleaching agent is carbamide peroxide or hydrogen peroxide.

10. The device according to claim 1, wherein said dental treatment agent is a medicament for teeth or gums.

11. The device according to claim 1, wherein said dental treatment agent is an oral hygiene agent for teeth and/or gums.

12. The device according to claim 11, wherein said dental treatment agent is fluoride.

13. A device for applying dental treatment agent to teeth and/or gums of a patient, comprising:
a plastic carrier having a soft, bitable plastic matrix with closed hollow spaces; and
dental treatment agent hermetically enclosed in said hollow spaces of said plastic matrix;
wherein said hollow spaces are opened when the patient bites the plastic matrix and the dental treatment agent is allowed to escape and contact the teeth and/or the gums of the patient.
